(19) United States
(12) Patent Application Publication
(10) Pub. No.: US 2014/0218515 A1
(43) Pub. Date: Aug. 7, 2014

(54) IMMEDIATE ACTION SYSTEM

(71) Applicant: SYSTEMS ENGINEERING TECHNOLOGIES CORPORATION, Alexandria, VA (US)

(72) Inventors: Luis Gil Armendariz, Stafford, VA (US); Aaron Luis Armendariz, Alexandria, VA (US); Jose Antonio Diaz, Alexandria, VA (US)

(73) Assignee: Systems Engineering Technologies Corporation, Alexandria, VA (US)

(21) Appl. No.: 13/875,451

(22) Filed: May 2, 2013

Related U.S. Application Data
(60) Provisional application No. 61/760,643, filed on Feb. 4, 2013.

(51) Int. Cl. G08B 23/00

(52) U.S. Cl. CPC G08B 23/00
USPC 348/143; 340/517

(57) ABSTRACT

Embodiments disclosed herein provide systems and methods for an immediate action system to transmit data associated with an emergency to first responders. The first responders may be provided with media at the location of the emergency that precede the emergency, media associated with when the emergency is triggered, as well as real-time media at the location of the emergency.

This application claims the benefit of U.S. Provisional Application No. 61/760,643, filed Feb. 4, 2013, which is hereby incorporated by reference in its entirety.

### TECHNICAL FIELD

This disclosure relates generally to systems and methods for an emergency notification system. Specifically, this disclosure relates to audio and video emergency notification systems for first responders.

### BACKGROUND

Conventional emergency notification systems facilitate the dissemination or broadcast of messages to individuals or groups of individuals. The broadcast messages notify or alert the individuals or groups of pending or existing emergency situations. Conventional emergency notification systems may continuously broadcast emergency messages associated with the status of emergency situations. The mechanisms utilized by conventional emergency messages to broadcast generic messages are inefficient or otherwise less than desirable.

First responders to an emergency may require additional or different information than what is provided in generic emergency response messages, which could be utilized by the first responders to control the emergency and save lives. Accordingly, needs exist for improved methods and systems for providing first responders to an emergency with information preceding the emergency, information associated with when the emergency is triggered, and real-time information associated with the emergency.

### SUMMARY

Embodiments disclosed herein provide systems and methods for an immediate action system to transmit data associated with an emergency to first responders. The first responders may be provided with media preceding the emergency at the location of the emergency, media associated with when the emergency is triggered, as well as real-time media at the location of the emergency.

In response to receiving the media, first responders may determine the cause of the emergency, receive current media associated with the emergency, and determine actions that should be implemented in response to the emergency. Further, responsive to receiving the media associated with what emergency trigged the emergency and the current state of the emergency, embodiments may limit, reduce, or remove additional dangers to first responders of the emergency.

In embodiments, an alert system may receive an emergency signal in response to a sensor being triggered. In response to receiving the emergency signal, the alert system may transmit an alarm signal including streaming media from a location associated with the sensor to the controller module. The streaming media may include a selectable media including video, audio, etc. stored at the alert system. The selectable media may be stored at the alert system before the emergency signal was transmitted and/or may be real-time media. The selectable media may be utilized by a first responder to determine what triggered the emergency signal.

In response to receiving the alarm signal including the streaming media, the controller module may transmit the received media to other devices, such as radios, smart phones, and/or computers that may be utilized by first responders to an emergency.

In embodiments, the processor may be communicatively coupled with emergency communications centers, such as 911, dispatch police, firefighters, etc. to transmit and/or receive media associated with emergencies.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 depicts an embodiment of a network topology of an immediate action system.

FIG. 2 depicts an embodiment of a method for an alert system to obtain and transmit data associated with an emergency.

FIG. 3 depicts an embodiment of a method for a controller module to receive and transmit data associated with an emergency.

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Embodiments of the present invention can be implemented in a computer communicatively coupled to a network (for example, the Internet, an intranet, an internet, a WAN, a LAN, a SAN, etc.), another computer, or in a standalone computer. As is known to those skilled in the art, the computer can include a central processing unit (“CPU”) or processor, at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, etc.), or the like. In embodiments of the invention, the computer has access to at least one database over the network.

ROM, RAM, and HD are computer memories for storing computer-executable instructions executable by the CPU or capable of being complied or interpreted to be executable by the CPU. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of C++, Java, JavaScript, HTML, or any other programming or scripting code. Other software/hardware/network architectures may be used. For example, the functions of the present invention may be implemented on one computer or shared among two or more computers. In one embodiment, the functions of the present invention may be distributed in the network. Communications between computers implementing embodiments of the invention can be accomplished using any electronic, optical, radio frequency signals, or other suitable methods and tools of communication in compliance with known network protocols.

It will be understood for purposes of this disclosure that a module is one or more computer processes, computing devices or both, configured to perform one or more functions. A module may present one or more interfaces which can be utilized to access these functions. Such interfaces include APIs, web services interfaces presented for a web services, remote procedure calls, remote method invocation, etc.

Embodiments disclosed herein provide systems and methods allowing first responders to receive data obtained at a location associated with an emergency. The data may include audio and/or video (referred to, independently and collectively, hereinafter as “media”) at the location that is obtained before a sensor associated with the emergency triggers an alarm. The data may also include real-time media associated with the emergency.

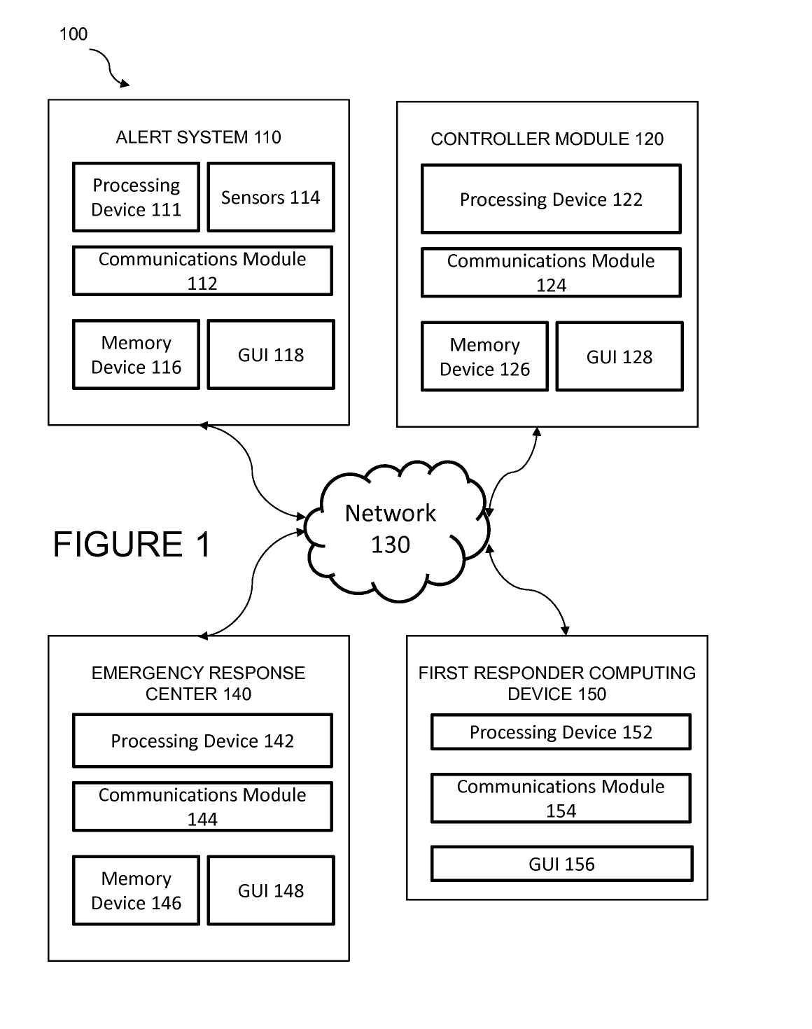

FIG. 1 depicts an embodiment of network topology 100 for an immediate action system. The network topology 100 includes one or more alert system(s) 110, a controller module 120, one or more emergency response center(s) 140, and first responder computing device 150 connected to each other over a network 130.

Network 130 may be a wired or wireless network such as the Internet, an intranet, a LAN, a WAN, a virtual private network (VPN), a cellular network, radio network, telephone network, and/or another type of network. It will be understood that network 130 may be a combination of multiple different kinds of wired or wireless networks. It will be further understood that network 130 may be configured to communicate packetized and/or encrypted data to devices within network topology 100.

Alert system 110 may be any type of computing device with a hardware processor that is configured to process instructions and connect to network 130, or one or more portions of network 130. Alert system 110 may be configured to obtain data and media associated with an emergency and transmit the media over network 130. Alert system 110 may also be configured to receive data and media associated with an emergency over network 130, and present the received data and media locally. In one embodiment, alert system 110 may include processing device 111, communications module 112, sensors 114, memory device 116, and graphical user interface (GUI) 118.

Processing device 111 may include memory, e.g., read only memory (ROM) and random access memory (RAM), storing processor-executable instructions, and one or more processors that execute the processor-executable instructions. In embodiments where processing device 111 includes two or more processors, the processors may operate in a parallel or distributed manner. Processing device 111 may execute an operating system of alert system 110 or software associated with other elements of alert system 110, such as received data and media associated with a location from sensors 114.

Communications module 112 may be a hardware device configured to communicate with another device, e.g., controller module 120 or one or more emergency response center(s) 140 over network 130. Communications module 112 may include one or more wireless transceivers for performing wireless communication and/or one or more communication ports for performing wired communication. In embodiments, communications module 112 may be configured to packetize data obtained from sensors 114, and communicate the packetized data over network 130 according to any known protocol, which in embodiments may be an encrypted protocol.

Sensors 114 may be hardware devices configured to monitor activity at a location. Sensors 114 may be utilized to obtain media and data at the location, which may be used to determine unusual activity, unauthorized activity, and/or any other type of activity that may require attention at the location, such as an emergency. In embodiments, sensors 114 may be positioned throughout a location, such as a home, school, church, or any other location where an emergency may arise, and a location of each of sensor 114 may be stored within memory device 116. Sensors 114 may include devices to record media, such as audio and/or video associated with an emergency. Sensors 114 may include a camera to record images, a microphone to record audio, vibration sensors to detect movement, pressure sensors to detect changes in pressure, a glass break detection sensor to detect audio frequencies associated with broken glass, a temperature sensor to detect changes in temperature, motion sensors to detect movement, contact sensors to detect if two objects (such as a door edge and door frame) are adjacent to each other, a button that when pressed signals an emergency, and/or other types of sensors. In embodiments, a sensor associated with a camera may be configured to record still images and/or videos, and a video resolution and/or the number of frames per second obtained by the camera may be configurable. Sensors 114 may be further configured to obtain data associated with the location, such as a temperature, pressure, etc. In response to sensors 114 obtaining data and media, sensors 114 may generate a time stamp associated with a time that the data and/or media was obtained. Sensors 114 may also be configured transmit the data and media to memory device 116. In response to memory device 116 receiving the data and media, processing device 111 may determine if an alarm trigger is met.

Memory device 116 may be a device that stores data generated or received by alert system 110. Memory device 116 may include, but is not limited to a hard disc drive, an optical disc drive, and/or a flash memory drive. In embodiments, memory device 116 may comprise non-transitory storage media that electronically stores data and media associated with alert system 110, such as data and media obtained from sensors 114, and alert thresholds associated with triggering an alarm. Memory device 116 may store a globally unique identifier for alert system 110, and a location of the alert system 110. The location of alert system 110 may be determined via real-time located system signals (RTLS), WiFi signals, GPS, Bluetooth, or any other mechanism to determine a location.

Memory device 116 may also be configured to store media, data, and other information obtained by sensors 114. Memory device 116 may also be configured to store a time stamp corresponding to a time that the media, data, and/or other information is obtained by sensors 114. In one embodiment, memory device 116 may store media obtained from sensors 114 in a circular buffer. The circular buffer may be configured to store media for any desired length of time. In embodiments, the circular buffer may store media previously obtained from sensors 114. Therefore, if an alarm is triggered, a first responder may be able to review media obtained via sensors 114 before the alarm is triggered to determine the cause of the trigger. In further embodiments, memory device 116 may be configured to store other data associated obtained from sensors 114, such as a temperature of the location, a binary signal indicating whether two contacts are in contact with each other to determine if a door and/or window is closed or opened, or any other type of data received from sensors 114. In one embodiment, memory device 116 may store a button threshold associated with whether two contacts are within a given proximity of each other, such as a binary threshold, a temperature threshold associated with a temperature that would trigger an alarm, etc. Other thresholds may be associated with an audio frequency associated with broken glass, a pressure sensor associated with a pressure at the location, etc. Memory device 116 may also be configured to store pre-recorded media that may be presented to users on GUI 118.

In embodiments, processing device 111 may compare received data from sensors 114 with the corresponding emergency thresholds stored within memory device 116 to determine if a trigger for an emergency is met. For example, if the temperature data received from sensors 114 is above or below a temperature threshold, then processing device 111 may determine that an alarm trigger associated with a temperature of the location is met. Processing device 111 may transmit an alarm signal associated with the triggered alarm. The alarm signal may include data and/media obtained from sensors 114, the globally unique identifier associated with the alert system 110, an identifier of the sensor that triggered the emergency, and the location of alert system 110. For example, in one embodiment, processing device 111 may transmit an alarm signal to controller module 120. The transmitted alarm signal may include information indicating that a temperature threshold has been met, the temperature obtained by sensor 114, media obtained by sensor 114 before the trigger was met and real-time media, and the location of alert system (e.g., Washington Middle School, room 213).

GUI 118 may be a device that allows a user to interact with alert system 110. While one GUI 118 is illustrated, the term “user interface” may include, but is not limited to being, a touch screen, a physical keyboard, a mouse, a microphone, and/or a speaker. GUI 118 may include a display configured to present media on the alert system, such as video, audio, pre-recorded messages, text based messages, etc.

Controller module 120 may be a computing device that is configured to communicate data over network 130, and may be communicatively coupled to alert system(s) 110, one or more emergency response center(s) 140, and first responder computing device 150. Controller module may include processing device 122, communications module 124, memory device 126, and GUI 128.

Processing device 122 may include memory, e.g., read only memory (ROM) and random access memory (RAM), storing processor-executable instructions and one or more processors that execute the processor-executable instructions. In embodiments where processing device 122 includes two or more processors, the processors may operate in a parallel or distributed manner. Processing device 122 may execute an operating system of controller module 120 or software associated with other elements of controller module.

Communications module 124 may be a hardware device configured to communicate with another device, e.g., alert system(s) 110 or one or more emergency response center(s) 140 via network 130. Communications module 124 may include one or more wireless transceivers for performing wireless communication and/or one or more communication ports for performing wired communication. In embodiments, communications module 124 may be configured to packetize data, which may be encrypted, and communicated over network 130 according to any known protocol. Communications module 124 may be configured to transmit audio data, push to talk (PTT) audio data, video data, and other data over any known protocol. In one embodiment, communications module 124 may be configured to receive an alarm signal from alert system 110. The alarm signal may include data associated with media recorded by the alert system 110 before the alarm is triggered, while the alarm is triggered, and after the alarm is triggered, a location of alert system 110, the globally unique identifier associated with the alert system 110 that transmitted the alarm signal, an identifier of the sensor that triggered the emergency, and the location of alert system 110.

Memory device 126 may be a device that stores data received from alert system 110, data GUI 128, and/or data computed by processing device 122. Memory device 126 may include, but is not limited to a hard disc drive, an optical disc drive, and/or a flash memory drive. In embodiments, memory device 126 may comprise non-transitory storage media that electronically stores data associated with alert system 110, data GUI 128, and/or data computed by processing device 122. Memory device 126 may be configured to store data and media and corresponding time stamps received from alert system 110, such as media at the location of alert system 110 that may be associated with an emergency. The media received from alert system 110 may be media within an alarm signal recorded before an alarm is triggered and real-time media. Therefore, memory device 126 may store a running log of the recorded media at alert system 110.

Memory device 126 may also be configured to store pre-recorded audio and/or video alerts to be presented on GUI 118 of alert system 110, emergency response center(s) 140, and/or first responder computing device 150. In one embodiment, the pre-recorded media may be audio data associated with a police siren. The pre-recorded media may be transmitted from controller module 120 and received by alert system 110. The alert system 110 may play the pre-recorded audio, simulating the arrival of first responders.

Memory device 126 may include a database including entries for each alert system 110. Each entry may include the globally unique identifier of alert system 110, the location of alert system 110, and media stored at alert system 110. Utilizing the database, processing device 122 may compare a received globally unique identifier within a received alarm signal with the globally unique identifiers within the database to determine which alert system 110 transmitted the alarm signal, and the location of the alert system 110 that triggered the alert utilizing the database.

GUI 128 may be a device that allows a user to interact with controller module 120. While one GUI 128 is illustrated, the term “graphical user interface” may include, but is not limited to being, a touch screen, a physical keyboard, a mouse, a microphone, and/or a speaker. GUI 128 may include a display configured to present data or media received from alert system 110, such as video, audio, pre-recorded messages, text based messages, etc. Responsive to receiving an alarm signal, GUI 128 may present an audible alarm and/or display visual indicators to users.

After presenting the audible and/or visual indicators on GUI 128, a user may enter commands on GUI 128 to be presented with media and other information associated with the alarm signal. In embodiments, the user may be required to input authorization data, such as a username and/or password, to be presented with the media and other information associated with the alarm signal. Utilizing GUI 128, the user may be presented with media included within the alarm signal, such as the media recorded before the alarm is triggered, media recorded while the alarm is triggered, and media recorded after the alarm is triggered. In one embodiment, media associated with a time period preceding the alarm signal may be automatically presented to the user in response to the user being presented with the audible and/or visual indicators of the alarm signal. Therefore, the user may be initially presented with media for a time period preceding the alarm signal to determine the cause of the alert signal. The time period preceding the alert signal may be any desired time period (e.g., ten seconds, one minute, five minutes, etc.). In embodiments, the time period may be based on the type of emergency triggering the alarm signal.

The user may utilize the media to determine what may have caused the alarm signal to be sent and/or determine the current situation at alert system 110. The data associated with the alarm signal may be transmitted from controller module 120 to emergency response center(s) 140 and/or first responder computing device 150 over network 130. In embodiments, the data associated with the alarm signal may be automatically transmitted, or the data may be transmitted responsive to GUI 128 receiving commands from the user to transmit the data.

In embodiments, GUI 128 may also be configured to allow a user to generate pre-recorded media, such as audio, video, etc. that may be transmitted over network 130. In embodiments, GUI 128 may also allow a user to search and locate media stored within memory device 126, which may be media associated with alert system 110, and present the stored media on GUI 128. In embodiments, GUI 128 may also be utilized to access alert system 110. GUI 128 may be configured to receive commands input by a user to select a sensor to present data or media associated with the selected sensor. For example, GUI 128 may present historical or real-time media associated with a camera on sensors 114.

Emergency response center 140 may be a computing device that is configured to communicate data over network 130, and may be communicatively coupled to alert system(s) 110, controller module 120, and first responder computing device 150. Emergency response center 140 may include processing device 142, communication module 144, memory device 146, and GUI 148.

Processing device 142 can include memory, e.g., read only memory (ROM) and random access memory (RAM), storing processor-executable instructions and one or more processors that execute the processor-executable instructions. In embodiments where processing device 142 includes two or more processors, the processors may operate in a parallel or distributed manner. Processing device 142 may execute an operating system of emergency response center 140 or software associated with other elements of emergency response center 140.

Communications module 144 may be a hardware device configured to communicate with another device. Communications module 144 may include one or more wireless transceivers for performing wireless communication and/or one or more communication ports for performing wired communication. In embodiments, communications module 144 may be configured to packetize data, which may be encrypted, communicated over network 130 according to any known protocol. Communications module 144 may be configured to transmit audio data, push to talk (PTT) audio data, video data, and other data over any known protocol. In embodiments, communications module 144 may be configured to communicate with first responder device 150 over a dedicated and secure channel. Further, communications module 144 may be configured to transmit data to a chief of police, governor's office, the office of the president, or other authorized personnel.

Memory device 146 may be a device that stores data received from controller module 120. Memory device 146 may include, but is not limited to a hard disc drive, an optical disc drive, and/or a flash memory drive. In embodiments, memory device 146 may comprise non-transitory storage media that electronically stores data. Memory device 146 may be configured to store data and/or media generated by alert system 110 or controller module 120, such as audio and/or video at the location of alert system 110, which may be associated with an emergency, or pre-recorded audio and/or video.

GUI 148 may be a device that allows a user to interact with emergency response system 140. While one GUI 148 is illustrated, GUI 148 but is not limited to being a touch screen, a physical keyboard, a mouse, a microphone, and/or a speaker. GUI 148 may include a display configured to present data associated with an alarm signal or media to users of emergency response center 140, such as video, audio, pre-recorded messages, text based messages, etc. GUI 148 may be configured to receive commands input by a user to transmit media to first responder computer device 150.

First responder computing device 150 may be a smart phone, radio, tablet computer, laptop computer, personal data assistant or any other type of mobile device with a hardware processor that is configured to process instructions and connect to network 130, or one or more portions of network 130. First responder computing device 150 may be configured to receive data from emergency response center 140 associated with an emergency at alert system 110. The received data may include a map specifying the location of the emergency, media associated with the emergency, or any other information associated with the emergency. First responder computing device 150 may include processing device 152, communications module 154, and GUI 156.

Processing device 152 can include memory, e.g., read only memory (ROM) and random access memory (RAM), storing processor-executable instructions and one or more processors that execute the processor-executable instructions. In embodiments where processing device 152 includes two or more processors, the processors may operate in a parallel or distributed manner. Processing device 152 may execute an operating system of first responder computing device 150 or software associated with other elements of first responder computing device 150.

Communications module 154 may be a hardware device configured to communicate with another device. Communications module 154 may include one or more wireless transceivers for performing wireless communication and/or one or more communication ports for performing wired communication. In embodiments, communications module 154 may be configured to packetize data, which may be encrypted, communicated over network 130 according to any known protocol. Communications module 154 may be configured to transmit audio data, push to talk (PTT) audio data, video data, and other data over any known protocol.

GUI 156 may be a device that allows a user to interact with first responder computing device 156. While one GUI 156 is illustrated, GUI 156 may include, but is not limited to being a touch screen, a physical keyboard, a mouse, a microphone, and/or a speaker. GUI 156 may include a display configured to present media associated with an alert signal on alert system 110, such as video, audio, pre-recorded messages, text based messages, etc. GUI 156 may be configured to receive commands input by a user to transmit media to other computing devices. In embodiments, GUI 156 may present media to a first responder associated with an emergency. The presented media may be media that occurred at the location of alert system 110 before an alarm is triggered, and/or real-time media at the location of alert system 110. GUI 156 may also be configured to allow first responders to communicate with other first responders and other devices within topology 100 via voice, text, and video. Responsive to being presented with the media associated with the alert signal, a first responder may be able to determine the cause of the alert and current dangers at the location of alert system 110.

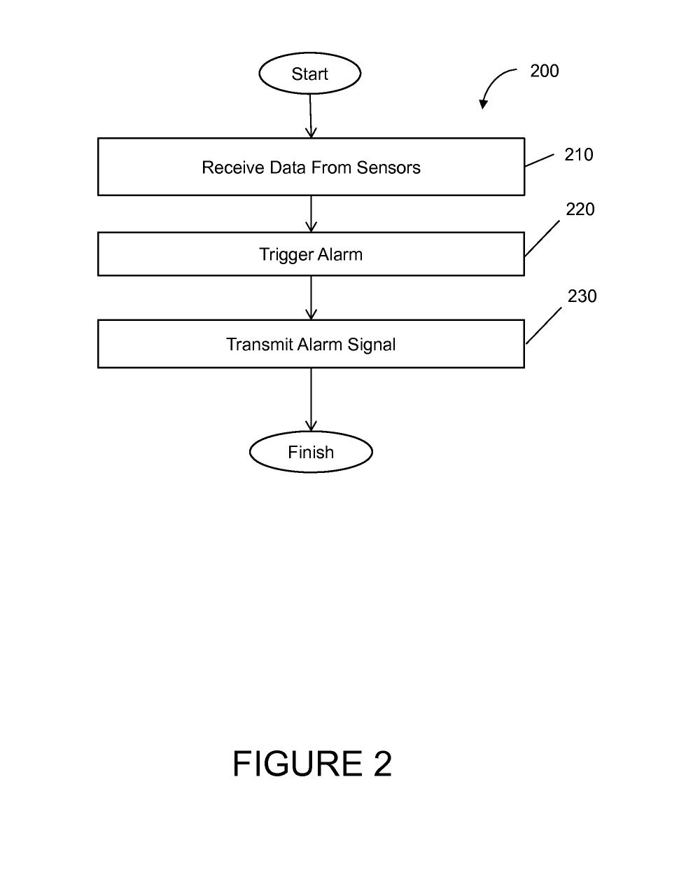

Turning now to FIG. 2, FIG. 2 depicts a method 200 for an alert system to transmit data and media. The steps of method 200 presented below are intended to be illustrative. In some embodiments, method 200 may be accomplished with one or more additional steps that are not described below, and/or without one or more of the steps described below. Additionally, the order in which the steps of method 200 are illustrated in FIG. 2 and described below is not intended to be limiting.

At step 210, data may be received from sensors. The data received from the sensors may include media, temperature data, pressure data, and/or any other type of data that may be utilized to determine activity at a location. The received data may be stored in a memory device. In one embodiment, the received data may be stored in a circular buffer, such that recently received data may be stored. The amount of data stored within the circular buffer may be of any size, such that media stored within the circular buffer may be maintained for a desired time period.

At step 220, an alarm may be triggered. The alert system may determine that the alarm is triggered in at least one of a plurality of ways, such as receiving a communication that an alarm button has been pressed to trigger the alarm. An alarm may also be triggered by comparing the received data from the sensors with sensor threshold data stored in the memory device, wherein the sensor threshold data may be associated with standard sensor measurements. If the received data indicates that a variable is greater than or less than a sensor threshold associated with a corresponding variable, then the alarm may be triggered.

At step 230, an alarm signal may be transmitted responsive to the alarm being triggered. The transmitted alarm signal may include data and media received from the sensor before the alarm is triggered, data and media received when the alarm is triggered, and data and media received in real-time. The transmitted alarm signal may also include the received sensor data and media, a location associated with the sensor that triggered the alarm, a globally unique identifier of the alert system, and a location of the alert system.

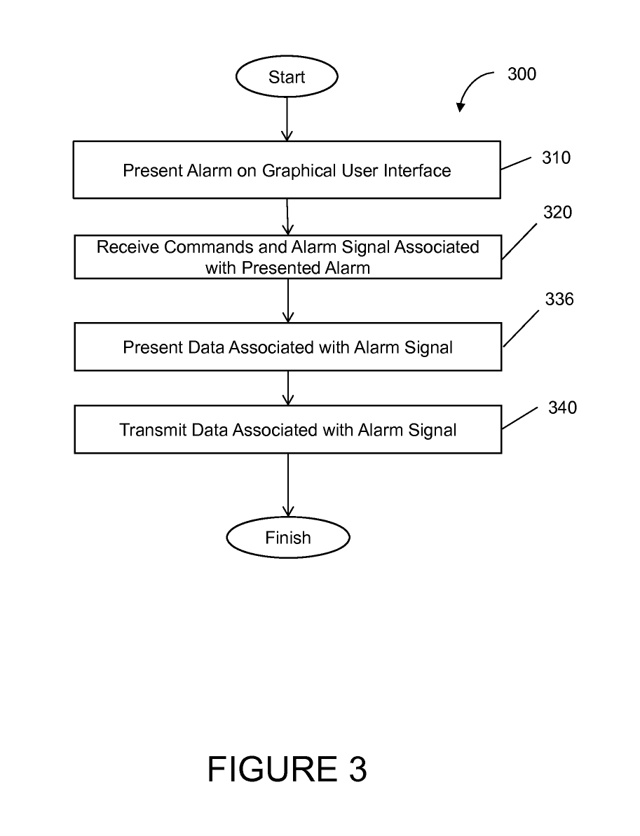

FIG. 3 depicts a method 300 for receiving and transmitting data and media with a controller module. The steps of method 300 presented below are intended to be illustrative. In some embodiments, method 300 may be accomplished with one or more additional steps that are not described below, and/or without one or more of the steps described below. Additionally, the order in which the steps of method 300 are illustrated in FIG. 3 and described below is not intended to be limiting.

At step 310, an alarm may be presented on a graphical user interface of a controller module. The alarm may include audio and/or visual alerts configured to notify an individual that the alert signal is received.

At step 320, responsive to user interactions on the graphical user interface indicating that a user has viewed the alarm presented on the graphical user interface, data and media associated with an alarm signal may be transmitted from an alert system and received by a controller module. The received alarm signal may include media received from a sensor before an alarm is triggered, data and media received when the alarm is triggered, and data and media received in real-time. The received alarm signal may also include a location associated with the sensor that triggered the alarm, a globally unique identifier of the alert system, and a location of the alert system. In embodiments, the transmitted media preceding the alarm being triggered may cover any desired length of time, which may be for example determined by empirical evidence, which may allow the user to view media associated with the location preceding the receipt of the alert signal.

At step 330, responsive to receiving the data associated with the alert signal, the data may be presented on the graphical user interface to a user. The data may include media associated with media received from the sensor before the alarm is triggered, media received while the alarm is triggered, and real-time media. In one embodiment, media associated with a time period preceding the alert signal may be automatically presented to the user, such that the user may determine the cause of the alarm signal. The time period preceding the alert signal may be any desired time period (e.g., ten seconds, one minute, five minutes, etc.). In embodiments, the time period may be based on the type of sensor that triggered the alert signal. For example, the time period associated with an alarm signal triggered by the push of a button may be different than the time period associated with an alarm signal triggered by a change in temperature at the location.

At step 340, the data associated with the alarm signal may be transmitted to a first responder's computing device and/or an emergency communications center. The first responder may utilize a graphical user interface of the computing device to view the data and media associated with the alarm signal, perform searches on the data associated with the alarm signal, and/or communicate with other devices.

In the foregoing specification, embodiments have been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It is also within the spirit and scope of the invention to implement in software programming or of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example, only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code).

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. For example, in some embodiments the controller module and emergency response center may be combined, or the alert system and controller module may be combined. Additionally, any signal arrows in the drawings/figures should be considered only as exemplary, and not limiting, unless otherwise specifically noted.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What I claim is:

1. An immediate action system comprising:
sensors configured to obtain media at a location, the media including audio data obtained via a microphone and visual data obtained via a camera;
a processor configured to determine that an alarm is triggered;
a memory device configured to store the obtained media and timestamps corresponding to when the media is obtained, the memory device comprising a circular buffer, the obtained media comprising media preceding the alarm being triggered and real-time media; and
a communications module configured to transmit an alarm signal in response to the alarm being triggered and to transmit the obtained media responsive to an indication that the alarm signal has been reviewed at a remote location.

2. The immediate action system of claim 1, wherein the communications module is configured to receive media that is recorded before the alarm is triggered, the media recorded before the alarm is triggered being configured to simulate the arrival of first responders to the remote location.

3. The immediate action system of claim 1, wherein the alarm is triggered by receiving an indication that a button has been pressed.

4. The immediate action system of claim 1, wherein the sensors are configured to gather data at the location, the data including at least one of a temperature of the location, noise data associated with the audio data obtained at the location, motion data associated with movement at the location.

5. The immediate action system of claim 1, wherein the alarm is configured to be triggered by different types of emergencies, and a time period covered by the media preceding the alarm being triggered is based on the type of emergency triggering the alarm.

6. The immediate action system of claim 1, wherein the alarm signal includes information associated with the location of the remote location and an identifier identifying a type of the alarm.

7. An immediate action system comprising:
a processor configured to present an indicator on a display of a graphical user interface in response to receiving an alarm signal, the alarm signal indicating that an alarm at a remote location is triggered;
a communications module configured to receive the alarm signal associated with the alarm being triggered, the alarm signal including media obtained from a sensor preceding the alarm being triggered and media obtained from the sensor after the alarm was triggered; and
a memory configured to store the media associated with the alert signal;
the graphical user interface being configured to receive commands indicating that a user has reviewed the indicator on the display of the graphical user interface, wherein responsive to receiving the commands indicating that the user has reviewed the indicator on the display of the graphical user interface the processor is configured to present the media obtained from the sensor preceding the alarm being triggered.

8. The system of claim 7, wherein the alarm signal includes information associated with the location of the remote location and an identifier identifying a type of the alarm.

9. The system of claim 7, wherein the alarm signal includes a predetermined number of frames of media obtained from the sensor.

10. The system of claim 7, wherein the alarm signal includes real-time media obtained from the sensor at the remote location.

11. The system of claim 7, wherein the communications module is further configured to transmit the received media, and receive commands to search the received media.

12. The system of claim 7, wherein the media includes timestamps corresponding to a time that the media was obtained.

13. The system of claim 7, wherein the memory device is configured to store media that is recorded before receiving the alarm signal, and transmit the media recorded before receiving the alarm signal to the remote location, the media recorded before receiving the alarm signal being configured to simulate the arrival of first responders to the remote location.

14. A method for an immediate action system comprising:
presenting an indicator on a display of a graphical user interface in response to receiving an alarm signal, the alarm signal indicating that an alarm at a remote location has been triggered;
receiving the alarm signal associated with the alarm being triggered, the alarm signal including media obtained from a sensor preceding the alarm being triggered and media obtained from the sensor after the alarm being triggered;
storing the media associated with the alert signal in a memory;
receiving commands indicating that a user has reviewed the indicator on the display of the graphical user interface; and
responsive to receiving the commands indicating that the user has reviewed the indicator on the display of the graphical user interface, presenting the media obtained from the sensor preceding the alarm being triggered.

15. The method of claim 14, wherein the alarm signal includes information associated with the location of the remote location and an identifier identifying a type of the alarm.

16. The method of claim 14, wherein the alarm signal includes a predetermined number of frames of media obtained from the sensor.

17. The method of claim 14, wherein the alarm signal includes real-time media obtained from the sensor at the remote location.

18. The method of claim 14, further comprising:
transmitting the received media to first responders; and
receiving commands to search the received media.

19. The method of claim 14, wherein the media includes timestamps corresponding to a time that the media is obtained.

20. The method of claim 14, further comprising:
storing media that is recorded before receiving the alarm signal; and
transmitting the media recorded before receiving the alarm signal to the remote location, the media recorded before receiving the alarm signal being configured to simulate the arrival of first responders to the remote location.
